(19) United States
(12) Patent Application Publication
(10) Pub. No.: US 2026/0322049 A1
(43) Pub. Date: Oct. 15, 2026

(54) INTERNET RECEPTACLE

(71) Applicant: JYH ENG TECHNOLOGY CO., LTD., New Taipei City (TW)

(72) Inventor: Yen-Lin LIN, New Taipei City (TW)

(21) Appl. No.: 19/174,061

(22) Filed: Apr. 9, 2025

(51) Int. Cl. H01R 24/64; H01R 107/00

(52) U.S. Cl. CPC H01R 24/64; H01R 2107/00; H01R 2201/04

(57) ABSTRACT

This disclosure is directed to an internet receptacle having an insulative seat and a plurality of terminals. The insulative seat has a positioning block, the positioning block has a first side and a second side away from the first side. The terminals are divided into a first terminal group at the first side and a second terminal group at the second side. Each terminal has an embedded segment embedded in the positioning block. In each terminal, the embedded segment has at least a portion on the edge which is laterally shifted relative to a central line of the terminal. Each embedded segment has a zigzag edge for embedding and adjusting a gap relative to another adjacent terminal for compensating to signals input to the terminals.

### BACKGROUND OF THE DISCLOSURE

### Technical Field

This disclosure is directed to an internet receptacle, in particular to an internet receptacle with input signal compensation.

### Description of Related Art

An internet cable has 8 core wires twisted into 4 twist pairs, the first twist pair is colored with white-orange and orange, the second twist pair is colored with white-green and green, the third twist pair is colored with white-blue and blue, and the fourth twist pair is colored with white-brown and brown. The core wires are arranged according to the internet regulations of T568A or T568B line position. For example, according to the T568B line position, the arrangement from 1 to 8 is white-orange, orange, white-green, blue, white-blue, green, white-brown, and brown.

It could be understood according to the line arrangement that the third line and the sixth line are connected to the same twist pair namely green and white-green lines, the fourth lines and the fifth line are connected to the same twist pair namely the blue and white-blue lines. The arrangement is not sequential. This generally leads to interference between the core wires caused by the two twist pairs mentioned above which is the so-called crosstalk interference.

In an internet receptacle module, in order to match the 1-8 sequence, the gold pins are also arranged from 1 to 8, and this also leads to crosstalk interference when transmitting signals. In the related art, various methods may be applied to eliminate the crosstalk interference, such as making compensation to the gold pins by specific shapes of rear ends of the gold pins, improving capacitive coupling, so as to eliminate the crosstalk.

Alternatively, a compensation circuit may be added to the printed circuit board to eliminate the crosstalk. A small compensation circuit board may be added to eliminate the crosstalk.

Another design of a double-layer arrangement of gold pins, in particular, the gold pins are divided into a front section and a rear section. The gold pins in the front section are connected to the compensation structure, and the gold pins in the rear section are connected to the main circuit board. A double-layer structure (bi-sectional) is formed between the front section and the rear section of the gold pins. When the plug is plugged, the front section gold pins are pressed down by the plug to contact the rear section gold pins at the double-layer structure. When the signals are transmitted from the plug to the socket, the signals are transmitted to the main circuit board and also compensated by the compensation structure connected to the front section gold pins, thereby reducing the crosstalk between the gold pins.

Another gold pin design has main gold pins and compensation gold pins. The main gold pins are connected to a main circuit board and extend free ends thereof forward, and each compensation gold pin has a compensation end and a support end. The compensation gold pins are disposed below the main gold pins corresponding to the main gold pin. The support ends abut against the main gold pins to provide support force, and capacitive couplings are formed at the compensation ends, so that when the plug is plugged, the transmitted signals are provided with crosstalk compensation through the compensation structure of the compensation end of the compensation gold pin.

Although the additional circuit board for compensation may effectively improve the characteristics of the internet receptacle, it also leads to cost increasing.

In views of this, in order to solve the above disadvantage, the inventor studied related technology and provided a reasonable and effective solution in this disclosure.

### SUMMARY OF THE INVENTION

The disclosure provides a photonic integrated circuit and an inspection method thereof, which may inspect the intensity, line width, and linearity of the laser light.

This disclosure is directed to an internet receptacle having an insulative seat and a plurality of terminals. The insulative seat has a positioning block, the positioning block has a first side and a second side away from the first side. The terminals are divided into a first terminal group at the first side and a second terminal group at the second side, each terminal has an embedded segment embedded in the positioning block. In each of the terminals, an edge of the embedded segment has at least a portion laterally shifted relative to a central line of the terminal.

In one embodiment of this disclosure, the embedded segments of the terminals in the first terminal group are respectively embedded in the positioning block at the first side, the terminals in the first terminal group has a first data delivering terminal, a third data receiving terminal, a fifth bilateral communication terminal and a seventh bilateral communication terminal. The embedded segments of the terminals in the second terminal group are respectively embedded in the positioning block at the second side, the terminals in the second terminal group have a second data delivering terminal, a fourth bilateral communication terminal, a sixth data receiving terminal and an eighth bilateral communication terminal. a gap between the embedded segment of the second data delivering terminal and the embedded segment of the fourth bilateral communication terminal is defined with a first width, a gap between the embedded segment of the fourth bilateral communication terminal and the embedded segment of the sixth data receiving terminal is defined with a second width, a gap between the embedded segment of the sixth data receiving terminal and the embedded segment of the eighth bilateral communication terminal has a portion defined with a second width and another portion defined with a third width. a gap between the embedded segment of the first data delivering terminal and the embedded segment of the third data receiving terminal has a portion defined with the second width and another portion defined with a third width, a gap between the embedded segment of the third data receiving terminal and the embedded segment of the fifth bilateral communication terminal is defined with the second width, a gap between the embedded segment of the fifth bilateral communication terminal and the embedded segment of the seventh bilateral communication terminal is defined with the first width. The first width is greater than the third width, and the second width is less than the third width.

In one embodiment of this disclosure, each of the terminals has a coupling segment, and the coupling segments of the terminals are arranged in a line in a sequence of the first data delivering terminal, the second data delivering terminal, the third data receiving terminal, the fourth bilateral communication terminal, the fifth bilateral communication terminal, the sixth data receiving terminal, the seventh bilateral communication terminal and the eighth bilateral communication terminal.

In one embodiment of this disclosure, each of the terminals has a plugging segment opposite to the coupling segment, and the plugging segment is provided with a pair of elastic arms.

In one embodiment of this disclosure, the internet receptacle further having a circuit board, each of the terminals having a plugging segment, and the plugging segments respectively plugged to the circuit board to electrically connect the terminals to the circuit board.

In one embodiment of this disclosure, each of the terminals has a plugging segment opposite to the coupling segment, and a compressible hole is arranged between the pair of elastic arms.

In one embodiment of this disclosure, the internet receptacle further having a circuit board, the circuit board provided with a plurality of conductive holes corresponding to the terminals respectively, and the plugging segment respectively plugged to the conductive holes to electrically connect the terminals with the circuit board respectively, wherein in each of the terminals, the plugging segment is deformed when plugged in the conductive hole correspondingly, so that the pair of elastic arms are closed to each other to abut against an internal edge of the conductive hole.

In one embodiment of this disclosure, the insulative seat has a pressing block, and the pressing block presses on the coupling segments along a direction from the second side to the first side.

In one embodiment of this disclosure, the insulative seat has a supporting block, and the terminals are supported by the supporting block along a direction from the first side to the second side.

In conclusion, according to this disclosure, each of the embedded segments of the terminals has a zigzag side edge, thereby not only enhancing embedded connections but also adjusting gaps between the embedded segments of the terminals in the internet receptacle, and further compensating characteristics of the signal input to each terminal.

### BRIEF DESCRIPTION OF THE DRAWINGS

FIG. 1 is an exploded view showing the internet receptacle according to an embodiment of this disclosure.

FIG. 2 is another exploded view showing the internet receptacle according to this disclosure.

FIG. 3 is another exploded view showing the internet receptacle according to this disclosure.

FIG. 4 is a perspective view showing the first terminal group assembled with the insulative seat according to the internet receptacle of this disclosure.

FIG. 5 is a perspective view showing the second terminal group assembled with the insulative seat according to the internet receptacle of this disclosure.

FIG. 6 is a perspective view showing an arrangement of the terminals in the first terminal group of the internet receptacle according to an embodiment of this disclosure.

FIG. 7 is a perspective view showing an arrangement of the terminals in the second terminal group of the internet receptacle according to an embodiment of this disclosure.

FIG. 8 is a cross-sectional view along a longitudinal direction of a terminal in the first terminal group of the internet receptacle according to an embodiment of the disclosure.

FIG. 9 is a cross-sectional view along a longitudinal direction of a terminal in the second terminal group of the internet receptacle according to an embodiment of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

It should be understood that the orientations or positional relationships in this disclosure which are indicated by the terms such as “front side”, “rear side”, “left side”, “right side”, “front end”, “rear end”, “end”, “vertical”, “horizontal”, “vertical”, “top” and “bottom” are based on the orientations or positional relationships as shown in the drawings. These are only used for describing this disclosure and simplifying the description rather than indicating or implying that the device or element have a specific orientation or be constructed and operated in a specific orientation, and it should not be considered as limitations of the scopes of this disclosure.

The terms used herein without additional definition such as “substantially” and “approximately” are used to describe and illustrate small changes. When used in an event or situation, the term may include the precise moment at which the event or situation occurs, and a close approximation to moment the event or situation occurs. For example, when combined with a numerical value, the term may include a range of variation less than or equal to ±10% of the numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Detailed descriptions and technical contents of this disclosure is described in the flowing paragraph with reference to the drawings. However, the drawings are attached only for illustration and are not intended to limit this disclosure.

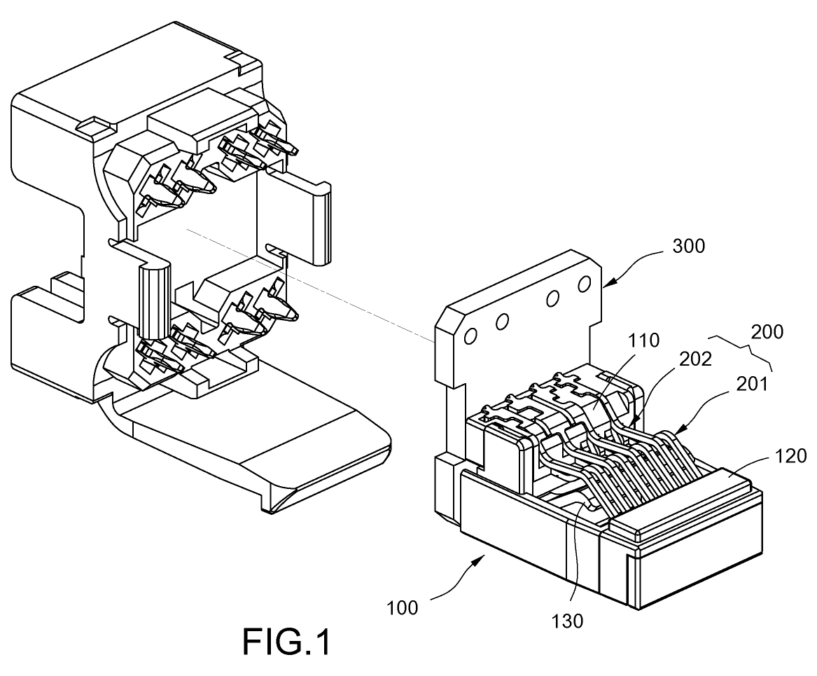

FIG. 1 is an exploded view showing the internet receptacle according to an embodiment of this disclosure. According to FIG. 1, this disclosure is directed to an internet receptacle at least having an insulative seat 100 and a plurality of terminals 200, and the internet receptacle of this disclosure further has a circuit board 300.

The insulative seat 100 has a positioning block 110, a pressing block 120 and a supporting block 130, the terminals 200 are respectively embedded in the positioning block 110, and the terminals 200 are divided into a first terminal group 201 and a second terminal group 202. The terminals 200 in the first terminal group 201 and the terminals 200 in the second terminal group 202 are alternately arranged in a row, the pressing block 120 and the supporting block 130 respectively abut against opposite sides of the row of terminals 200.

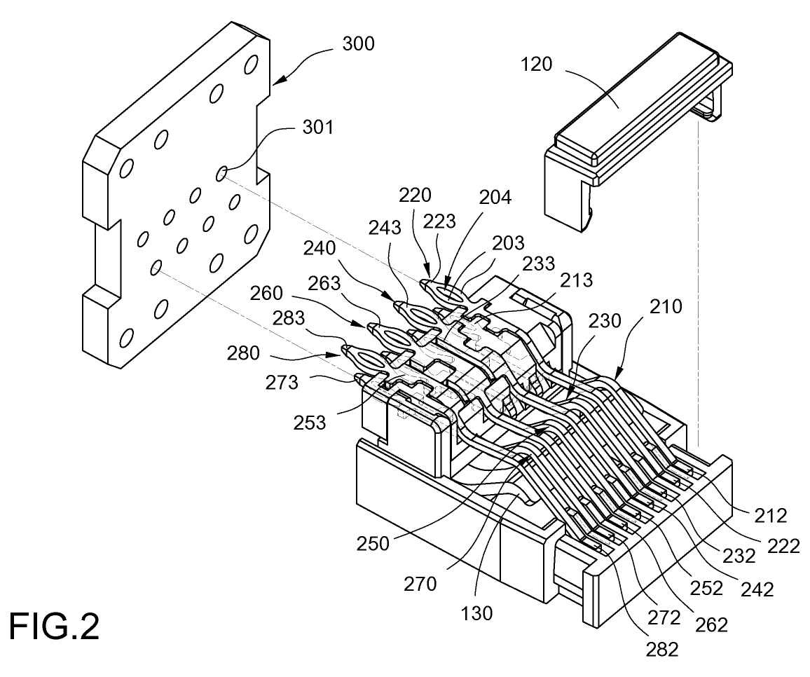

FIG. 2 is another exploded view showing the internet receptacle according to this disclosure. According to FIG. 2, the terminals 200 have a first data delivering terminal 210, a second data delivering terminal 220, a third data receiving terminal 230, a fourth bilateral communication terminal 240, a fifth bilateral communication terminal 250, a sixth data receiving terminal 260, a seventh bilateral communication terminal 270 and an eighth bilateral communication terminal 280.

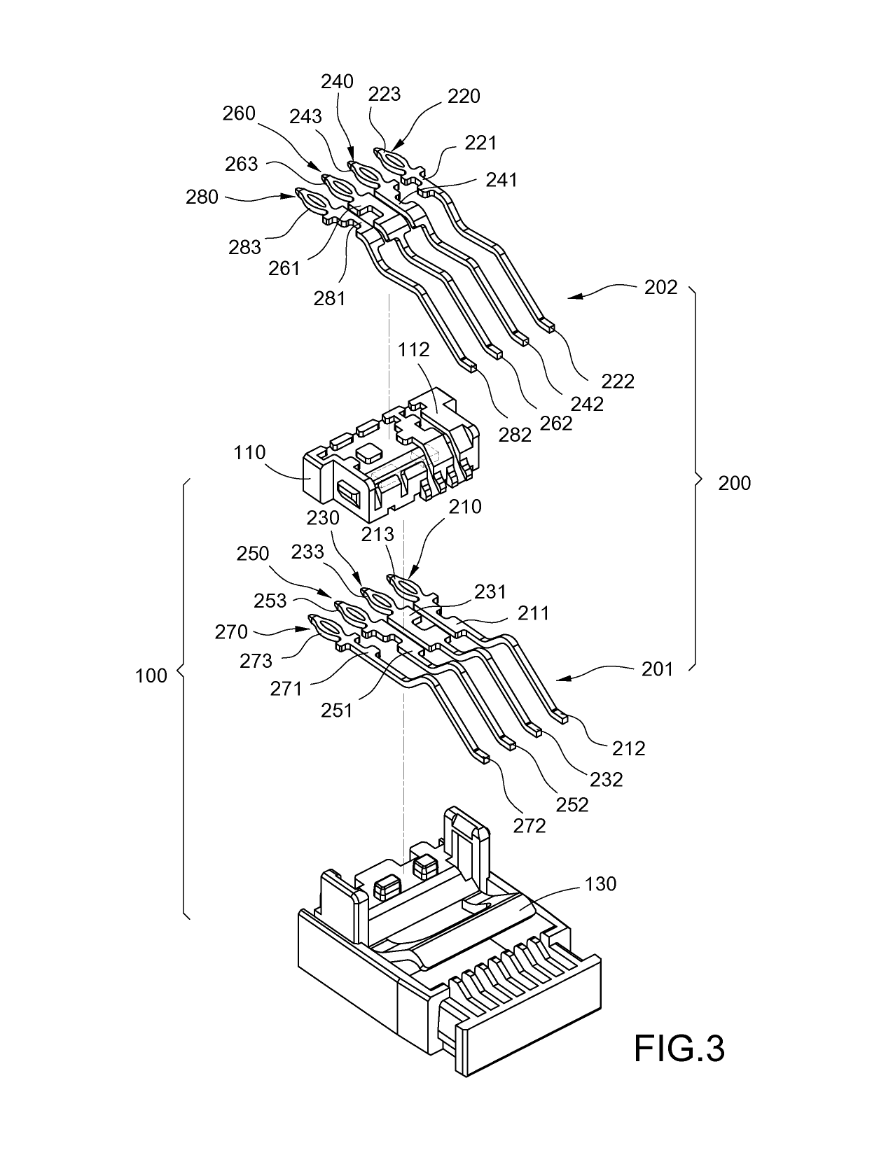

FIG. 3 is another exploded view showing the internet receptacle according to this disclosure. According to FIG. 3, the terminals 200 in the first terminal group 201 have the first data delivering terminal 210, the third data receiving terminal 230, the fifth bilateral communication terminal 250 and the seventh bilateral communication terminal 270. The terminals 200 in the second terminal group 202 have the second data delivering terminal 220, the fourth bilateral communication terminal 240 the sixth data receiving terminal 260 and the eighth bilateral communication terminal 280.

According to FIGS. 2 and 3, each of the terminals 200 has an embedded segment (211, 221, 231, 241, 251, 261, 271, 281) embedded in the positioning block 110. In each of the terminals 200, the embedded segment (211, 221, 231, 241, 251, 261, 271, 281) has a portion on an edge thereof which is laterally shifted relative to a central line of the terminals 200. Each of the terminals 200 has a coupling segment (212, 222, 232, 242, 252, 262, 272, 282), and the terminals 200of the coupling segments (212, 222, 232, 242, 252, 262, 272, 282) are arranged in a row in a sequence of the first data delivering terminal 210, the second data delivering terminal 220, the third data receiving terminal 230, the fourth bilateral communication terminal 240, the fifth bilateral communication terminal 250, the sixth data receiving terminal 260, the seventh bilateral communication terminal 270 and the eighth bilateral communication terminal 280.

According to the internet receptacle of this disclosure the gaps between the embedded segments (211, 221, 231, 241, 251, 261, 271, 281) of the internal terminals 200 may be adjusted for characteristic compensation. Specifically, the embedded segments (211, 221, 231, 241, 251, 261, 271, 281) of the terminals 200 are sheets with zigzag edges, so as to adjust the gaps between adjacent terminals 200. The smaller the gap between adjacent terminals 200, the stronger the capacitive property of the signals therein, and the larger the distance between adjacent terminals 200, the stronger the inductive property of the signals therein.

Each of the terminals 200 has a plugging segment (213, 223, 233, 243, 253, 263, 273, 283) opposite to the coupling segment (212, 222, 232, 242, 252, 262, 272, 282), and a pair of elastic arms 203 is disposed on the plugging segment (213, 223, 233, 243, 253, 263, 273, 283). A compressible hole 204 is defined between the pair of elastic arms 203. The plugging segments (213, 223, 233, 243, 253, 263, 273, 283) are plugged into the circuit board 300 to electrically connect the terminals 200 with the circuit board 300 respectively. According to this embodiment, the circuit board 300 is provided with a plurality of conductive holes 301 corresponding to the terminals 200. The plugging segments (213, 223, 233, 243, 253, 263, 273, 283) are plugged into the conductive holes 301 respectively, so as to electrically connect the terminals 200 to the circuit board 300. In each of the terminals 200, the plugging segments (213, 223, 233, 243, 253, 263, 273, 283) are deformed when plugged into the conductive holes 301 respectively, so that the pair of elastic arms 203 are moved toward the compressible hole 204 to be close to each other and cause an elastic force, and an internal edge of the conductive hole 301 is loaded with the elastic force.

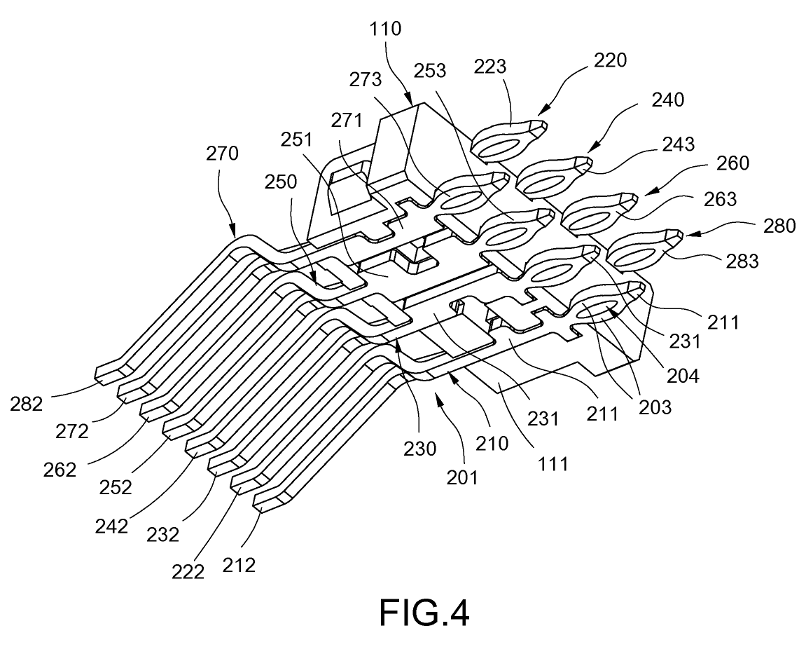

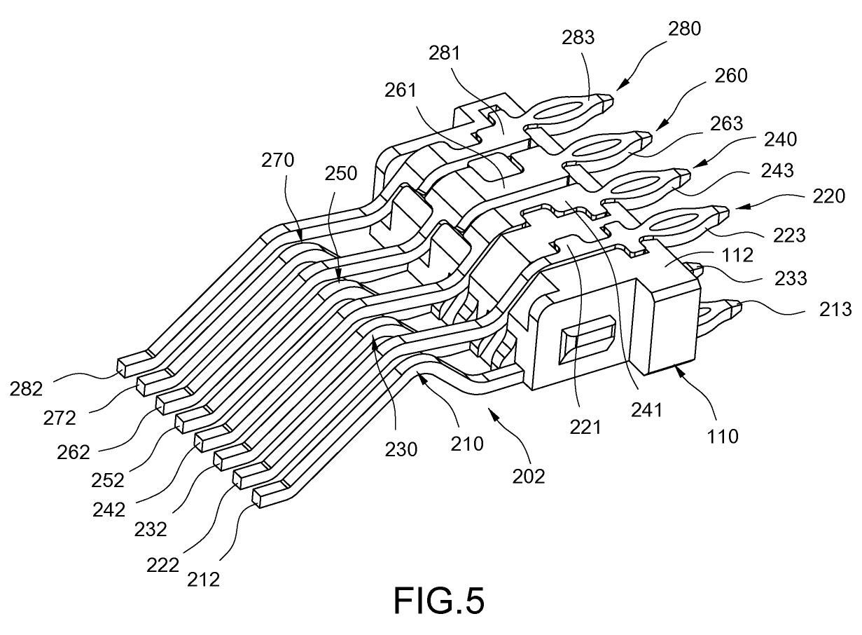

FIG. 4 is a perspective view showing the first terminal group assembled with the insulative seat according to the internet receptacle of this disclosure. FIG. 5 is a perspective view showing the second terminal group assembled with the insulative seat according to the internet receptacle of this disclosure. According to FIGS. 4 and 5, the positioning block 110 has a first side 111 as shown in FIG. 4 and a second side 112 shown in FIG. 5, the first side 111 and the second side 112 are disposed away from each other.

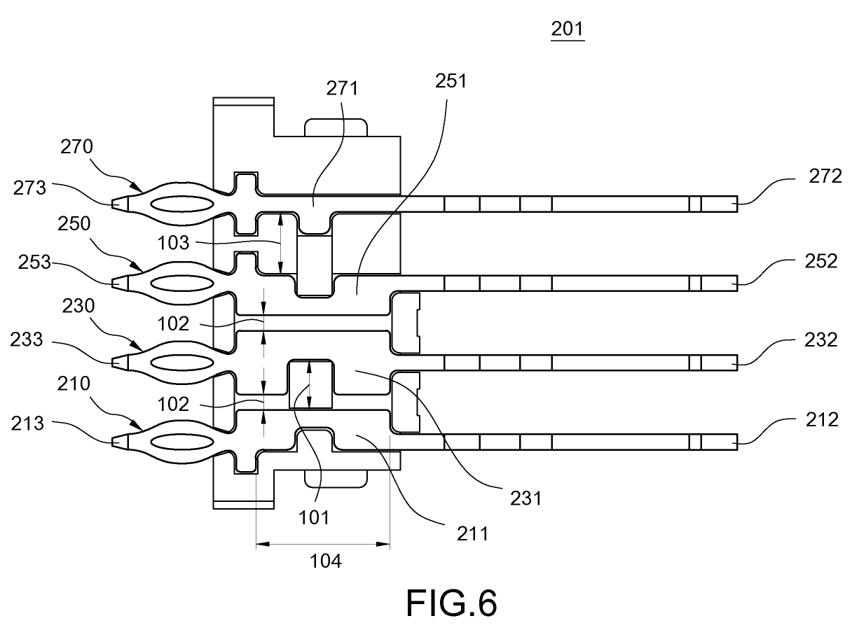

FIG. 6 is a perspective view showing an arrangement of the terminals in the first terminal group of the internet receptacle according to an embodiment of this disclosure. According to FIGS. 4 and 6, the first terminal group 201 is disposed at the first side 111 of the positioning block 110. Specifically, in the first terminal group 201, the embedded segments (211, 231, 251, 271) of the first data delivering terminal 210, the third data receiving terminal 230, the fifth bilateral communication terminal 250 and the seventh bilateral communication terminal 270 are embedded in the positioning block 110 at the first side 111, and the embedded segments (211, 231, 251, 271) are embedded in the positioning block 110 within the embedded area 104 as shown in FIG. 6.

According to FIG. 6, a gap between the embedded segment 211 of the first data delivering terminal 210 and the embedded segment 231 of the third data receiving terminal 230 has a portion defined with a first width 101 and another portion defined with a second width 102, a gap between the embedded segment 231 of the third data receiving terminal 230 and the embedded segment 251 of the fifth bilateral communication terminal 250 is defined with a second width 102, a gap between the embedded segment 251 of the fifth bilateral communication terminal 250 and the embedded segment 271 of the seventh bilateral communication terminal 270 is defined with a third width 103. The first width 101 is greater than the second width 102 and the first width 101 is less than the third width 103.

Specifically, in the first terminal group 201, the embedded segment 231 of the third data receiving terminal 230 and the embedded segment 251 of the fifth bilateral communication terminal 250 has longitudinal edges laterally protruded toward each other, and a gap therebetween is defined with the second width 102. An effective coupling length about 3.6~3.8 mm is formed between the embedded segment 231 of the third data receiving terminal 230 and the embedded segment 251 of the fifth bilateral communication terminal 250. A recessed notch is formed on the longitudinal edge of the third data receiving terminal 230 corresponding to a contour of the insulative seat 100 for embedding.

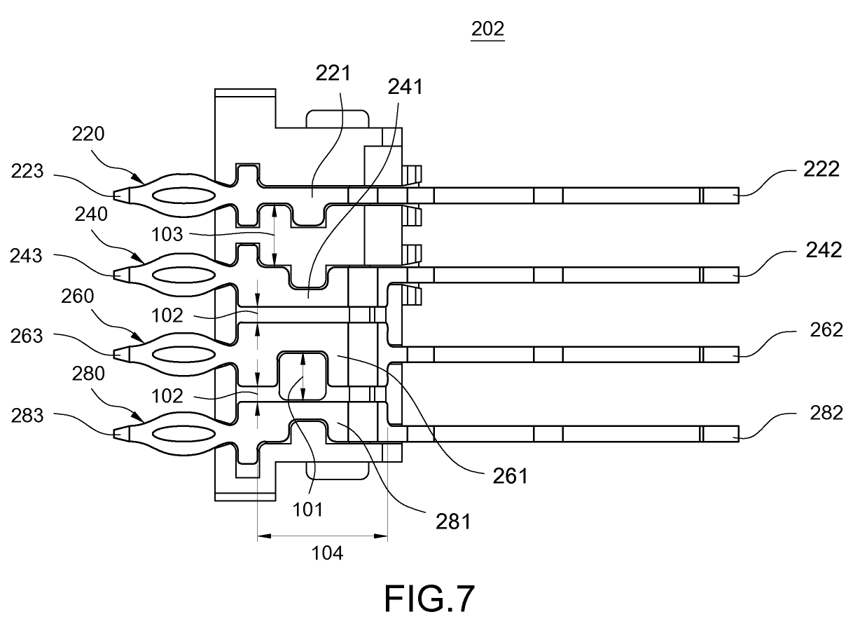

FIG. 7 is a perspective view showing an arrangement of the terminals in the second terminal group of the internet receptacle according to an embodiment of this disclosure. According to FIGS. 5 and 7, the second terminal group 202 is arranged on the positioning block 110 at the second side 112. Specifically, in the second terminal group 202, the embedded segments (221, 241, 261, 281) of the second data delivering terminal 220, the fourth bilateral communication terminal 240, the sixth data receiving terminal 260 and the eighth bilateral communication terminal 280 are respectively embedded in the positioning block 110 at the second side 112, and the embedded segments (221, 241, 261, 281) are embedded in the positioning block 110 within the embedded area 104 as shown in FIG. 7.

According to FIG. 7, a gap between the embedded segment 221 of the second data delivering terminal 220 and the embedded segment 241 of the fourth bilateral communication terminal 240 is defined with a the third width 103, a gap between the embedded segment 241 of the fourth bilateral communication terminal 240 and the embedded segment 261 of the sixth data receiving terminal 260 is defined with a the second width 102, a gap between the embedded segment 261 of the sixth data receiving terminal 260 and the embedded segment 281 of the eighth bilateral communication terminal 280 has a portion defined with the first width 101 and another portion defined with the second width 102.

Specifically, in the second terminal group 202, the embedded segment 241 of the fourth bilateral communication terminal 240 and the embedded segment 261 of the sixth data receiving terminal 260 has longitudinal edges laterally protruded toward each other, and a gap therebetween is defined with the second width 102. An effective coupling length about 3.6~3.8 mm is formed between the embedded segment 241 of the fourth bilateral communication terminal 240 and the embedded segment 261 of the sixth data receiving terminal 260. A recessed notch is formed on the longitudinal edge of the sixth data receiving terminal 260 corresponding to a contour of the positioning block 110 for embedding.

Referring to FIGS. 6 and 7, it should be considered that an over wide embedded segment may lead to increasing of self-inductance and mutual inductance. Considering characteristics, the adjacent side edges of the fourth bilateral communication terminal 240 and the sixth data receiving terminal 260 are maintained straight and the adjacent side edges of the third data receiving terminal 230 and the fifth bilateral communication terminal 250 are maintained straight. Accordingly, an effective coupling length between a wire pair connected to the third data receiving terminal 230 and the sixth data receiving terminal 260 and a wire pair connected to the fourth bilateral communication terminal 240 and the fifth bilateral communication terminal 250 can be extended to increase compensation.

A recess is disposed on a portion of a side edge of the embedded segment 231 of the third data receiving terminal 230 adjacent to a side edge of the embedded segment 211 of the first data delivering terminal 210, so that a coupling compensation between the first data delivering terminal 210 and the third data receiving terminal 230 may be decreased. In addition, a corresponding compensation circuit is added on the circuit board 300.

A recess is disposed on a portion of a side edge of the embedded segment 261 of the sixth data receiving terminal 260 adjacent to a side edge of the embedded segment 281 of the eighth bilateral communication terminal 280, so that a coupling compensation between the sixth data receiving terminal 260 and the eighth bilateral communication terminal 280 may be decreased. In addition, a corresponding compensation circuit is added on the circuit board 300.

Recesses are respectively disposed on outer edges of middle portions of the embedded segments (211, 281) of the first data delivering terminal 210 and the eighth bilateral communication terminal 280, so as to increase inductance and support via a shape corresponding to the counter of the insulating seat 100.

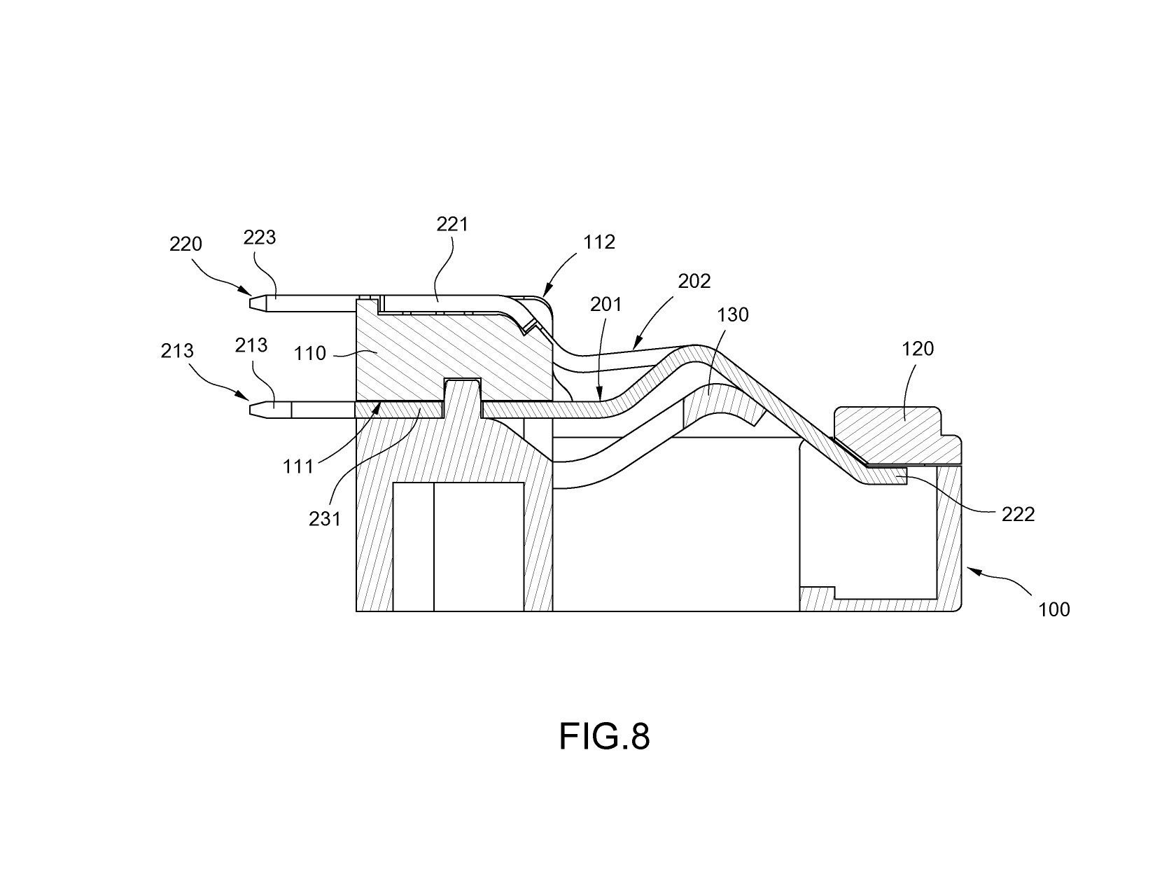

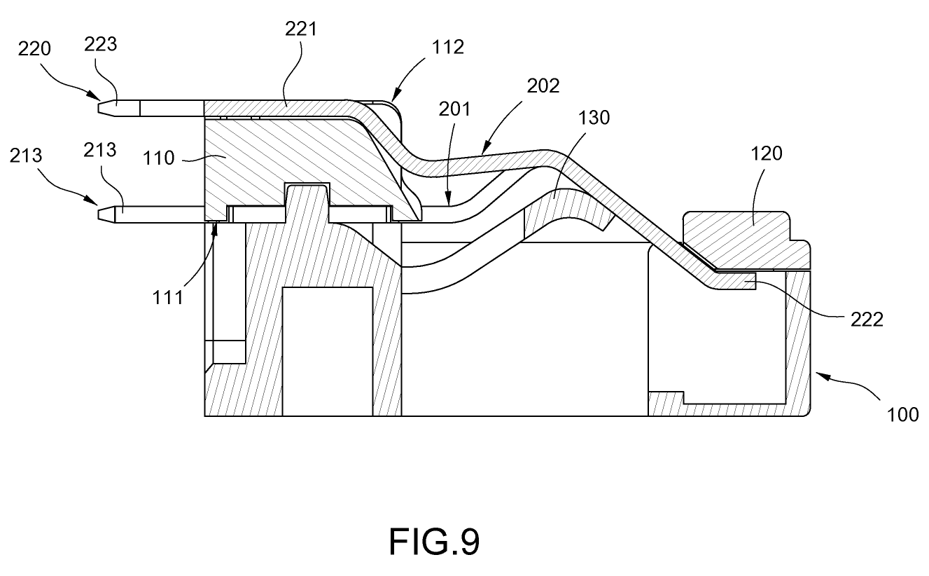

FIG. 8 is a cross-sectional view along a longitudinal direction of a terminal in the first terminal group of the internet receptacle according to an embodiment of the disclosure. FIG. 9 is a cross-sectional view along a longitudinal direction of a terminal in the second terminal group of the internet receptacle according to an embodiment of the disclosure. According to FIGS. 8 and 9, the pressing block 120 presses on the coupling segment (212, 222, 232, 242, 252, 262, 272, 282) along a direction from the second side 112 to the first side 111. The supporting block 130 supports the terminals 200 along a direction from the first side 111 to the second side 112.

In conclusion, according to this disclosure, each of the embedded segments (211, 221, 231, 241, 251, 261, 271, 281) of the terminals 200 has a zigzag side edge, thereby not only enhancing embedded connections but also adjusting gaps between the embedded segments (211, 221, 231, 241, 251, 261, 271, 281) of the terminals 200 in the internet receptacle, and further compensating characteristics of the signal input to each terminal 200.

While this disclosure has been described by means of specific embodiments, numerous modifications and variations may be made thereto by those skilled in the art without departing from the scope and spirit of this disclosure set forth in the claims.

What is claimed is:

1. An internet receptacle, comprising:
an insulative seat, comprising a positioning block, the positioning block comprising a first side and a second side away from the first side; and
a plurality of terminals, divided into a first terminal group disposed at the first side and a second terminal group disposed at the second side, each of the terminals comprising an embedded segment embedded in the positioning block,
wherein in each of the terminals, the embedded segment comprises a portion of an edge laterally shifted relative to a central line of the terminal.

2. The internet receptacle according to claim 1, wherein the embedded segments of the terminals in the first terminal group are respectively embedded in the positioning block at the first side, the terminals in the first terminal group comprises a first data delivering terminal, a third data receiving terminal, a fifth bilateral communication terminal and a seventh bilateral communication terminal;
wherein the embedded segments of the terminals in the second terminal group are respectively embedded in the positioning block at the second side, the terminals in the second terminal group comprises a second data delivering terminal, a fourth bilateral communication terminal, a sixth data receiving terminal and a eighth bilateral communication terminal;
wherein a gap between the embedded segment of the second data delivering terminal and the embedded segment of the fourth bilateral communication terminal is defined with a first width, a gap between the embedded segment of the fourth bilateral communication terminal and the embedded segment of the sixth data receiving terminal is defined with a second width, a gap between the embedded segment of the sixth data receiving terminal and the embedded segment of the eighth bilateral communication terminal comprises a portion defined with a second width and another portion defined with a third width;
wherein a gap between the embedded segment of the first data delivering terminal and the embedded segment of the third data receiving terminal comprises a portion defined with the second width and another portion defined with a third width, a gap between the embedded segment of the third data receiving terminal and the embedded segment of the fifth bilateral communication terminal is defined with the second width, a gap between the embedded segment of the fifth bilateral communication terminal and the embedded segment of the seventh bilateral communication terminal is defined with the first width;
wherein the first width is greater than the third width, and the second width is less than the third width.

3. The internet receptacle according to claim 2, wherein each of the terminals comprises a coupling segment, and the coupling segments of the terminals are arranged in a line in a sequence of the first data delivering terminal, the second data delivering terminal, the third data receiving terminal, the fourth bilateral communication terminal, the fifth bilateral communication terminal, the sixth data receiving terminal, the seventh bilateral communication terminal and the eighth bilateral communication terminal.

4. The internet receptacle according to claim 3, wherein each of the terminals comprises a plugging segment opposite to the coupling segment, and the plugging segment is provided with a pair of elastic arms.

5. The internet receptacle according to claim 1, further comprising a circuit board, each of the terminals comprising a plugging segment, and the plugging segments respectively plugged to the circuit board to electrically connect the terminals to the circuit board.

6. The internet receptacle according to claim 5, wherein each of the terminals comprises a plugging segment opposite to the coupling segment, and a compressible hole is arranged between the pair of elastic arms.

7. The internet receptacle according to claim 4, further comprising a circuit board, the circuit board provided with a plurality of conductive holes corresponding to the terminals respectively, and the plugging segment respectively plugged to the conductive holes to electrically connect the terminals with the circuit board respectively, wherein in each of the terminals, the plugging segment is deformed when plugged in the conductive hole correspondingly, so that the pair of elastic arms are closed to each other to abut against an internal edge of the conductive hole.

8. The internet receptacle according to claim 3, wherein the insulative seat comprises a pressing block, and the pressing block presses on the coupling segments along a direction from the second side to the first side.

9. The internet receptacle according to claim 1, wherein the insulative seat comprises a supporting block, and the terminals are supported by the supporting block along a direction from the first side to the second side.
